(19) United States
(12) Patent Application Publication
(10) Pub. No.: US 2026/0023450 A1
(43) Pub. Date: Jan. 22, 2026

(54) Touch control method based on display information

(71) Applicant: NOVATEK Microelectronics Corp., Hsin-Chu (TW)

(72) Inventors: Tso-Hua Chien, Hsinchu City (TW); Shang-Ming Tai, Miaoli County (TW)

(73) Assignee: NOVATEK Microelectronics Corp., Hsin-Chu (TW)

(21) Appl. No.: 19/095,005

(22) Filed: Mar. 30, 2025

Related U.S. Application Data
(60) Provisional application No. 63/672,267, filed on Jul. 17, 2024.

(51) Int. Cl. G06F 3/041

(52) U.S. Cl. CPC G06F 3/04182; G06F 3/0412

(57) ABSTRACT

A method of controlling a touch panel for a driver circuit, which has a display part and a touch part, includes steps of: generating, by the display part, a display information according to a plurality of display data for the touch panel; receiving, by the touch part, the display information from the display part; and performing, by the touch part, a touch sensing operation according to the display information.

### CROSS REFERENCE TO RELATED APPLICATIONS

This application claims the benefit of U.S. Provisional Application No. 63/672,267, filed on Jul. 17, 2024. The content of the application is incorporated herein by reference.

### BACKGROUND OF THE INVENTION

### 1. Field of the Invention

The present invention relates to a touch control method, and more particularly, to a touch control method performed on a touch panel.

### 2. Description of the Prior Art

In various electronic products such as mobile phones, GPS navigator systems, monitors, laptops and computers, a touch panel is widely utilized as the interface for data communication. Touch sensing operations and display operations are both performed on the touch panel, to realize the integration of touch and display functions. However, the touch sensing operations performed on the touch panel are easily interfered with by various noises, especially those noises generated from the display operations. In the prior art, the touch control circuit may not know the display information or data when performing touch sensing, and thus it is difficult to deal with the noise interferences generated from the display operations.

### SUMMARY OF THE INVENTION

It is therefore an objective of the present invention to provide a method of controlling a touch panel for a display driver circuit to eliminate or reduce the display noises, so as to improve the performance of touch sensing.

An embodiment of the present invention discloses a method of controlling a touch panel for a driver circuit. The driver circuit has a display part and a touch part. The method comprises steps of: generating, by the display part, a display information according to a plurality of display data for the touch panel; receiving, by the touch part, the display information from the display part; and performing, by the touch part, a touch sensing operation according to the display information.

Another embodiment of the present invention discloses a method of controlling a touch panel for a driver circuit. The driver circuit has a display part and a touch part. The method comprises steps of: determining, by the display part, a periodicity of a plurality of lines of display data; receiving, by the touch part, an information of the periodicity from the display part; and determining, by the touch part, to start a touch sensing operation at a time point according to the periodicity.

Another embodiment of the present invention discloses a method of controlling a touch panel for a driver circuit. The driver circuit has a display part and a touch part. The method comprises steps of: determining, by the display part, a display information of a plurality of display data; receiving, by the touch part, the display information from the display part; and controlling, by the touch part, a frequency setting of a touch sensing operation according to the display information.

Another embodiment of the present invention discloses a method of controlling a touch panel for a driver circuit. The driver circuit has a display part and a touch part. The method comprises steps of: determining, by the display part, a display information of a plurality of display data; receiving, by the touch part, the display information from the display part; and setting, by the touch part, a filter for a touch sensing operation according to the display information.

Another embodiment of the present invention discloses a method of controlling a touch panel for a driver circuit. The driver circuit has a display part and a touch part. The method comprises steps of: providing, by the display part, a brightness information of the touch panel to the touch part; and calibrating, by the touch part, a touch data of a touch sensing operation according to the brightness information.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a display system according to an embodiment of the present invention.

FIG. 2 illustrates how the display operation generates noises to interfere with the touch sensing operation.

FIG. 3 is a schematic diagram of an exemplary implementation of the driver circuit.

FIG. 4 illustrates the display content of an image frame analyzed by the DP to determine the display information.

FIG. 5 is a flowchart of a touch control process according to an embodiment of the present invention.

FIG. 6 illustrates the touch sensing operation performed in a display frame period according to an embodiment of the present invention.

FIG. 7 illustrates the touch sensing operation performed in a display frame period with a numeral example.

FIG. 8 illustrates the touch sensing operation performed in a display frame period with different regions having different image patterns.

FIG. 9 is a flowchart of a touch control process according to an embodiment of the present invention.

FIG. 10 illustrates the touch sensing operation performed in one of multiple candidate frequencies based on the SNR under different image patterns.

FIG. 11 is a flowchart of a touch control process according to an embodiment of the present invention.

FIG. 12 illustrates an exemplary setting of a touch filter to deal with the noises generated by a 7H pattern according to an embodiment of the present invention.

FIG. 13 is a flowchart of a touch control process according to an embodiment of the present invention.

FIG. 14 illustrates the touch raw data of an image frame affected by the brightness of the image according to an embodiment of the present invention.

FIG. 15 is a flowchart of a touch control process according to an embodiment of the present invention.

### DETAILED DESCRIPTION

In general, a touch panel is controlled by a driver circuit, which may provide display data for the touch panel to realize the display function, and also perform touch sensing on the touch panel to realize the touch sensing function. In various embodiments, the driver circuit may be implemented as an integrated circuit (IC) included in a chip, such as a touch with display driver integration (TDDI) IC. Different from the conventional touch panel where the display function and the touch sensing function are performed by different ICs, the TDDI IC deals with both of the display and touch sensing functions; hence, the TDDI IC may perform touch sensing by considering information associated with the display operations. For example, the TDDI IC may obtain the display data to be sent to the touch panel, thereby predicting possible noises that may be generated by the display operation. Therefore, the touch sensing operation may be performed accordingly, in order to avoid the noise interferences.

Nowadays, the driver circuit may detect noises appearing on the touch panel during the touch sensing operation, so as to control or modify related touch settings to reduce the noise interferences; hence, the anti-noise operation is performed after the noises are detected. Differently, in the present invention, the driver circuit performs touch sensing based on predicted display characteristics, so that the noises that may appear on the touch panel could be predicted, thereby avoiding possible noise interferences in advance.

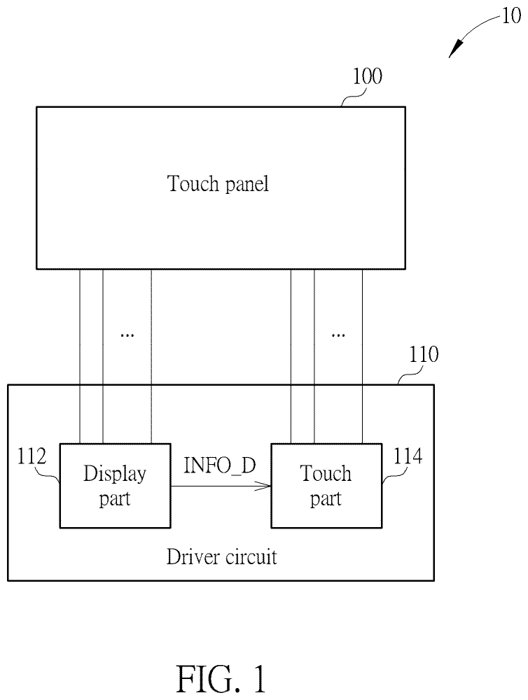

FIG. 1 is a schematic diagram of a display system 10 according to an embodiment of the present invention. The display system 10 includes a touch panel 100 and a driver circuit 110. The touch panel 100 may be a display panel integrated with a touch sensor. The touch sensor may be implemented on or embedded in the display panel by using any touch technique, which may include, but not limited to, the in-cell, on-cell and out-cell touch panel. The display panel may be of any type, which may include, but not limited to, the light-emitting diode (LED) panel, organic LED (OLED) panel, and liquid crystal display (LCD) panel.

In order to control both the display and touch sensing operations, the driver circuit 110 may be a TDDI IC. As shown in FIG. 1, the driver circuit 110 includes a display part (DP) 112 and a touch part (TP) 114. The DP 112 and the TP 114 may be two circuit blocks coupled to each other.

The DP 112 is responsible for the display operations, which may be realized in various manners. For example, the touch panel 100 may include an active area in which a pixel array is deployed, and include gate-on-array (GOA) circuits deployed at both sides of the active area. The DP 112 may output display data to the pixels in the active area, and also output control signals to the GOA circuits, to control the pixels to be scanned in an appropriate manner to receive the corresponding display data.

The TP 114 is responsible for the touch sensing operations, which may also be realized in various manners. For example, the TP 114 is coupled to a touch sensor array deployed on the touch panel 100, to receive touch sensing signals from the touch sensor to determine the existence of a touch object and the related touch behavior. The TP 114 may perform touch sensing with any technique, such as the capacitive touch sensing, resistive touch sensing, and optical touch sensing, but not limited thereto.

The DP 112 and the TP 114 may communicate with each other to improve the performance of the display and touch sensing operations. In some embodiments, the DP 112 may generate display information INFO_D according to the display data to be sent to the touch panel 100. The TP 114 may receive the display information INFO_D from the DP 112, to perform the touch sensing operation accordingly. For example, the TP 114 may determine a noise that may be generated from the display data according to the received display information INFO_D, thereby performing the touch sensing operation to avoid the interference of the noise. In other words, according to the display data to be output to the touch panel 100 in a future time point, the noise interferences that might affect the touch sensing operation may be predicted. Based on the noise information, the TP 114 may take appropriate measures to eliminate or reduce the noise interferences generated from the display operation.

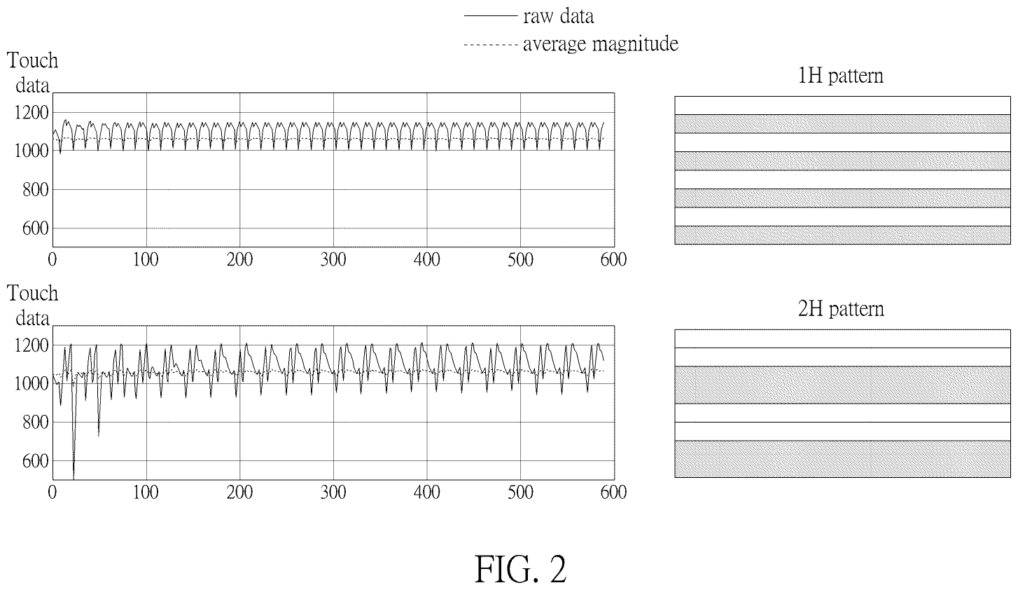

FIG. 2 illustrates how the display operation generates noises to interfere with the touch sensing operation, where several image patterns with corresponding touch data obtained by the TP 114 are shown. In detail, FIG. 2 illustrates a 1H pattern and a 2H pattern. The 1H pattern is an image pattern having 1 row of white image and 1 row of black image appearing alternately and periodically, and the 2H pattern is an image pattern having 2 rows of white image and 2 rows of black image appearing alternately and periodically.

The touch data may be a series of raw data values obtained by the TP 114 over a period of time (i.e., by scanning the touch sensor array on the touch panel 100 and sampling the touch data), under the display of the 1H pattern or the 2H pattern. If there is no noise, the obtained touch data may be constant or only have a small variation. With the image pattern that may interfere with the touch sensing operation, the values of the touch data may have an evident up-down variation. A larger variation may cause the touch data to deviate from its accurate value, thereby generating a wrong touch report and affecting the touch sensing performance. As shown in FIG. 2, the 1H pattern and the 2H pattern may generate different noise patterns, which may have different frequency components and/or different average magnitudes to affect the touch data differently.

Therefore, the DP 112 is used to analyze the display data to determine the image pattern and/or related data characteristics, and then send the corresponding information to the TP 114, allowing the TP 114 to perform appropriate processing during the touch sensing operation, so as to cancel the noise interference. For example, the TP 114 may know that the 1H pattern may have a specific noise profile. If the display information INFO_D received from the DP 112 indicates that the 1H pattern is to be displayed on the touch panel 100, the TP 114 may perform touch sensing in an appropriate manner that would not generate interferences under the specific noise profile.

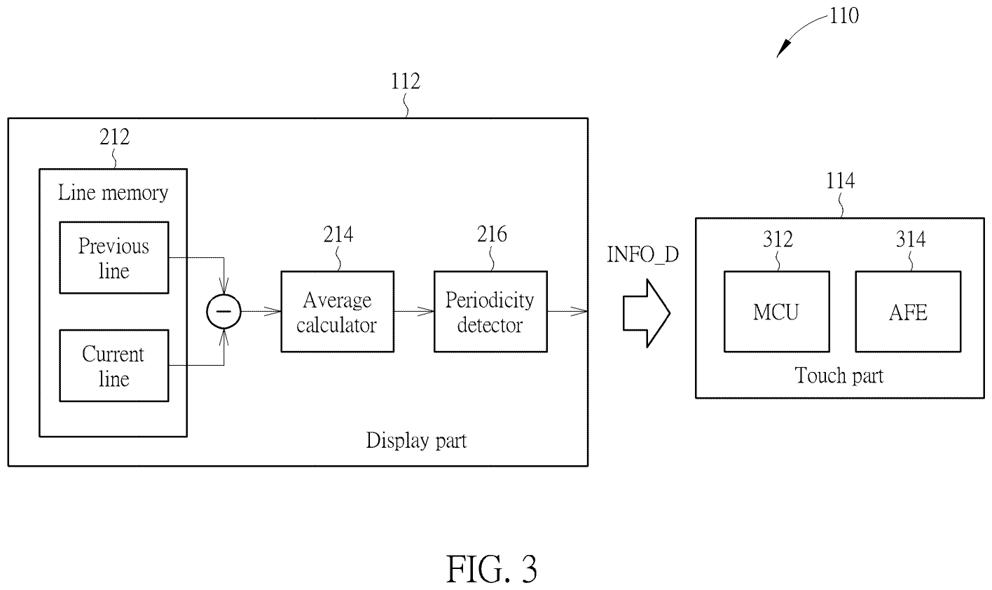

FIG. 3 is a schematic diagram of an exemplary implementation of the driver circuit 110. In detail, the DP 112 includes a line memory 212, an average calculator 214 and a periodicity detector 216. The line memory 212 stores the display data which is to be used for determining the display characteristics. In one or several embodiments, the line memory 212 may store several lines of display data, among which one or more previous lines and one or more current lines may be compared, to obtain the data difference between the previous line(s) of display data and the current line(s) of display data. The data difference may indicate the noise strength that may be applied to the touch sensing operation. For example, a larger data difference may result in a larger noise.

In an embodiment, the previous line(s) of display data and the current line(s) of display data may be in an image frame; therefore, the DP 112 may calculate the data difference between two different line data in the same image frame, so as to determine the image pattern. In another embodiment, the previous line(s) of display data and the current line(s) of display data may be in different image frames; hence, the DP 112 may calculate the data difference of the same line(s) in different image frames, so as to obtain the trends of brightness variations. In fact, the DP 112 may perform data comparison in any appropriate manner, to obtain necessary display information INFO_D required by the TP 114 to satisfy various anti-noise requirements for touch sensing.

In addition, the average calculator 214 may determine the average of the display data within an image frame or a region in the image frame. The average of the display data may refer to an average grayscale of the display data, which indicates an average brightness in a region or a frame. Based on the information of the data difference and the data average, the periodicity detector 216 may determine the periodicity of the display data within a display section, and send the related information to the TP 114. For example, the periodicity detector 216 may obtain a series of data differences of multiple lines of display data, to find the rule of the data differences, thereby determining the periodicity of these display data.

The TP 114 includes a microcontroller unit (MCU) 312 and an analog front-end (AFE) circuit 314. The MCU 312 may control the touch sensing operation according to the display information INFO_D obtained from the DP 112. Therefore, if the touch sensing is performed when the display data is output, the MCU 312 may take appropriate measures to avoid the noise interferences of the display data. For example, the MCU 312 may select optimal timing and/or frequency for the touch sensing, in order to minimize the noise interferences.

The AFE circuit 314 may serve as an interface used to communicate with the touch sensor array on the touch panel. In an embodiment, if the capacitive touch sensing is applied, the AFE circuit 314 may output touch driving signals to one or more touch sensors, and correspondingly receive touch sensing signals from the touch sensors, where the touch sensing signals may reflect the capacitive coupling of a touch object if the touch object is contacting or approaching the touch panel 100. The AFE circuit 314 then sends the touch sensing signals to the MCU 312. The MCU 312 thereby analyzes the touch sensing signals to determine the touch gesture and position, or forwards the touch sensing signals to a host device to perform subsequent determinations. The detailed structure of the AFE circuit 314 may be well known by a person of ordinary skill in the art, and will not be narrated herein.

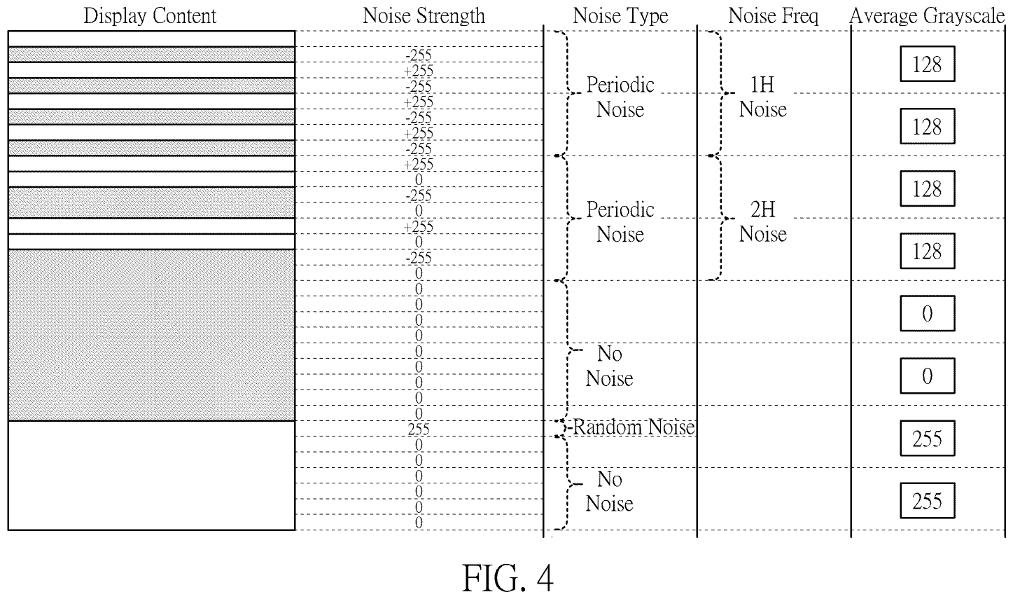

FIG. 4 illustrates the display content of an image frame analyzed by the DP 112 to determine the display information INFO_D, which may include the noise information, image pattern, and/or average grayscale. In order to determine the display characteristics more precisely, the frame of display data is divided into multiple regions to be analyzed. In this embodiment, the 1H pattern, 2H pattern, black image, and white image are shown in different regions. Assuming that the white image corresponding to the grayscale value 255 and that the black image corresponding to the grayscale value 0, by comparing two adjacent lines of display data, the noise strength may be equal to 255 when the image changes from black to white, and equal to −255 when the image changes from white to black. The noise generated from the data difference will cause a variation on the received touch raw data, where the positive and negative noise strength may generate positive and negative variations, respectively.

Based on the information of data differences, the DP 112 (e.g., the periodicity detector 216) may determine the noise type; that is, to determine whether the noise is periodic. As shown in FIG. 4, the 1H pattern and the 2H pattern may generate periodic noises since the line data changes periodically, and the noise frequency may be detected based on the data differences in a series of comparison results. The white region and the black region may not generate any noise since the display data remains unchanged in these regions. A random noise may be detected at the border between different image regions since this noise has no periodicity.

In addition, the DP 112 (e.g., the average calculator 214) may determine the average grayscale in each region. As shown in FIG. 4, the average grayscale of the 1H pattern and the 2H pattern is equal to a medium value 128, the average grayscale of the black region is equal to the minimum value 0, and the average grayscale of the white region is equal to the maximum value 255. The average grayscale may correspond to an average brightness on the touch panel, where the average brightness may affect the touch raw data. In detail, a larger grayscale value and larger brightness may be accompanied by higher currents flowing through the pixel circuits on the touch panel, thereby generating a larger parasitic capacitance. The parasitic capacitance may be coupled to the touch sensor, to cause the touch raw data received from the touch sensor to have modified values, which may be pushed upwards or downwards under different brightness. In order to overcome this issue, the overall data variations caused by the average brightness should be calibrated, to obtain an accurate touch sensing result. Therefore, the display information INFO_D provided for the TP 114 may include the information of average grayscale or average brightness in a frame or a region, allowing the TP 114 to calibrate the touch data accordingly.

With the data characteristics and related information as illustrated in FIG. 4, the TP 114 may perform touch sensing in an appropriate manner to avoid the noise interferences. For example, the touch sensing operation may be performed with a setting suitable for the 1H pattern when the 1H pattern image is displayed, or may be performed with another setting suitable for the black image when the black image is displayed.

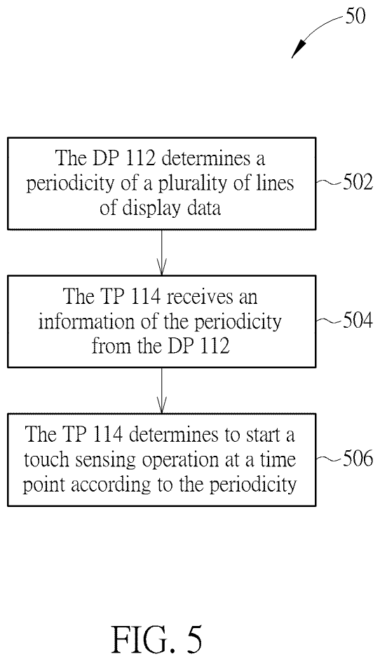

In one or several embodiments, the TP 114 may determine the timing of performing touch sensing according to the display information INFO_D obtained from the DP 112. FIG. 5 is a flowchart of a touch control process 50 according to an embodiment of the present invention. The touch control process 50 may be implemented in a driver circuit for a touch panel, such as the driver circuit 110 shown in FIG. 1 or 3. As shown in FIG. 5, the touch control process 50 includes the following steps:
Step 502: The DP 112 determines a periodicity of a plurality of lines of display data.
Step 504: The TP 114 receives an information of the periodicity from the DP 112.
Step 506: The TP 114 determines to start a touch sensing operation at a time point according to the periodicity.

According to the touch control process 50, the DP 112 first determines the periodicity of multiple lines of display data. For example, in the above embodiments, the period of the 1H pattern is 2 lines, and the period of the 2H pattern is 4 lines. Under the periodicity of the line data, the noises may appear to have the same periodicity. Therefore, the TP 114 may perform touch sensing in a timing conforming to the periodicity of the line data, so as to minimize the influences of the noises. In other words, the TP 114 may start a touch sensing operation at a time point according to the periodicity of the line data.

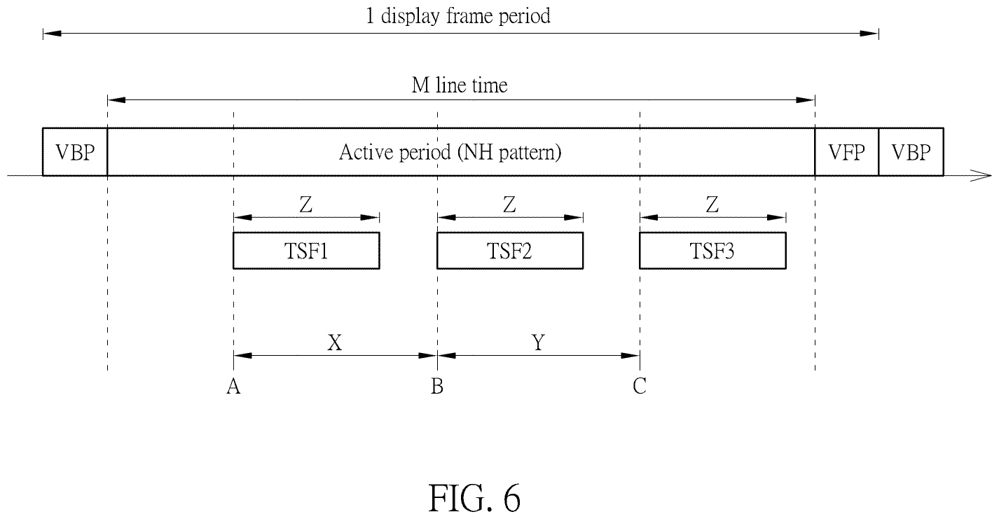

FIG. 6 illustrates the touch sensing operation performed in a display frame period according to an embodiment of the present invention, where the display frame period includes a vertical back porch (VBP), an active period and a vertical front porch (VFP). The display data is delivered in the active period. The active period may include M line time, where each line time is allocated to send a line of display data, and M may be any value corresponding to the resolution of the touch panel. For example, if the touch panel has a resolution 1080×1920 with 1080 columns and 1920 rows of pixels, M may be equal to 1920.

In this embodiment, it is assumed that the display data in this image frame has an NH pattern, where N may be any positive integer and is usually far smaller than M. This means that there are N lines of white data and N lines of black data output alternately. In such a situation, the period of the image pattern is 2N lines. Based on the required touch sensing frequency, one display frame period may contain one or several touch sensing frames. In this embodiment, 3 touch sensing frames TSF1-TSF3 having an equal width Z are included in the display frame period. The width Z may be set appropriately to satisfy the touch sensing requirements.

According to the present invention, the touch sensing frames TSF1-TSF3 may be allocated in an appropriate manner according to the display information INFO_D, which may include the periodicity of the display data. In detail, the touch sensing frame TSF1 starts at a time point A, the touch sensing frame TSF2 starts at a time point B, and the touch sensing frame TSF3 starts at a time point C. The time point A may correspond to a first line of display data (e.g., the A^{th} line data of the touch panel), the time point B may correspond to a second line of display data (e.g., the B^{th} line data of the touch panel), and the time point C may correspond to a third line of display data (e.g., the C^{th} line data of the touch panel). The distance between the time points A and B is X lines, and the distance between the time points B and C is Y lines. The values of X and Y may be identical or different.

In one or several embodiments, the touch sensing frames TSF1-TSF3 may be allocated to satisfy a criterion that each of X and Y is a multiple of 2N, which is the period of the NH pattern. In such a situation, the first line of display data at the time point A, the second line of display data at the time point B, and the third line of display data at the time point C may have the same data characteristic. In other words, the touch sensing frames TSF1-TSF3 start from the same position of different cycles of line data variations. For example, in the NH pattern with N lines of white data and N lines of black data outputting alternately, the first, second and third lines of display data may all be pure white data, or may all be pure black data.

Therefore, as long as the display data is periodic and the distance between the start points of different touch sensing frames is equal to a multiple of the period length, the line data at the start points would have exactly the same data values; that is, the first, second and third lines of display data at the start points of the touch sensing frames TSF1-TSF3 have the same data values (e.g., the same grayscale values). For example, if the touch sensing frame TSF1 starts with a line of white data, the other touch sensing frames TSF2 and TSF3 may also start with a line of white data.

In addition, the value of X or Y should be greater than Z, so that the touch sensing frames TSF1-TSF3 will not overlap and interfere with each other. Further, if the touch sensing frame TSF3 is the last one in the display frame period and starts with the C^{th} line data, C+Z may preferably be equal to or smaller than M; that is, the touch sensing frame TSF3 should be completed before the end of the active period.

As can be seen, the touch sensing frames TSF1-TSF3 start with the same data characteristic and also have the same width Z, so these touch sensing frames TSF1-TSF3 may undergo the same data difference and variation due to the periodicity of the display data. More specifically, a data difference corresponding to the first line of display data (which may be generated by comparing the first line of display data with an adjacent line of display data) may be equal to a data difference corresponding to the second line of display data (which may be generated by comparing the second line of display data with an adjacent line of display data), and also equal to a data difference corresponding to the third line of display data (which may be generated by comparing the third line of display data with an adjacent line of display data). As a result, the touch sensing operations performed in the touch sensing frames TSF1-TSF3 may undergo the same noise profile.

Note that the touch sensing behavior may be identical in the touch sensing frames TSF1-TSF3; that is, the TP 114 may apply the touch signals in the same manner, such as applying to the touch sensors in the same sequence by using the same signal waveform. Therefore, the touch signals in the touch sensing frames TSF1-TSF3 are accompanied by the output of the same display data having identical sequence, and thus may be interfered with by the same noise profile resulting from the display data. In such a situation, the backend processor may deal with the noises by using the same base line for the touch sensing frames TSF1-TSF3, thereby effectively reducing the noise interferences.

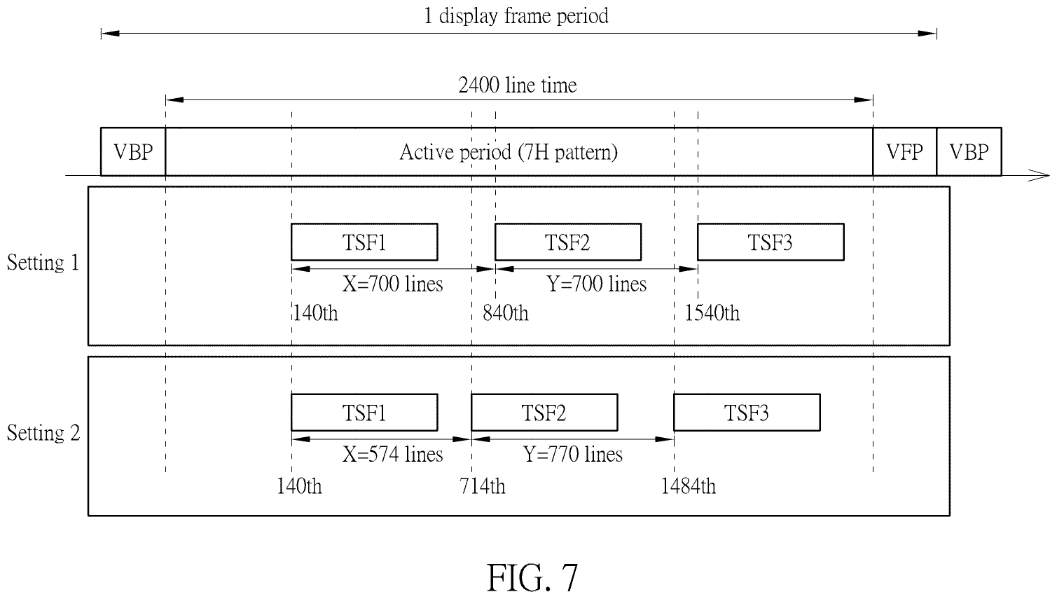

FIG. 7 illustrates the touch sensing operation performed in a display frame period with a numeral example. In this embodiment, the display frame period has 2400 line times in its active period, and the display data has a 7H pattern, which has 7 rows of white image and 7 rows of black image appearing alternately and periodically, and thus the output period of the line data is 14.

In setting 1, the touch sensing frame TSF1 starts at the 140^{th} line, the touch sensing frame TSF2 starts at the 840^{th} line, and the touch sensing frame TSF3 starts at the 1540^{th} line. In such a situation, the distance X between the start points of the touch sensing frames TSF1 and TSF2 is equal to 700 lines, and the distance Y between the start points of the touch sensing frames TSF2 and TSF3 is equal to 700 lines. Therefore, both X and Y are a multiple of 14, and thus setting 1 is feasible for noise reduction.

In setting 2, the touch sensing frame TSF1 starts at the 140^{th} line, the touch sensing frame TSF2 starts at the 714^{th} line, and the touch sensing frame TSF3 starts at the 1484^{th} line. In such a situation, the distance X between the start points of the touch sensing frames TSF1 and TSF2 is equal to 574 lines, and the distance Y between the start points of the touch sensing frames TSF2 and TSF3 is equal to 770 lines. Therefore, both X and Y are a multiple of 14, and thus setting 2 is also feasible for noise reduction.

Note that the H pattern (i.e., horizontal line pattern) is an image pattern having more data variations that may generate a larger noise to interfere with the touch sensing operation. In another embodiment, if an image frame includes image data which are a mixture of different image patterns, and an H pattern appears in parts of the image frame, the touch sensing frames may be allocated to keep away from the time period(s) in which the display data of the H pattern are output to the touch panel. In other words, the touch sensing frames may be allocated to the region(s) without the H pattern.

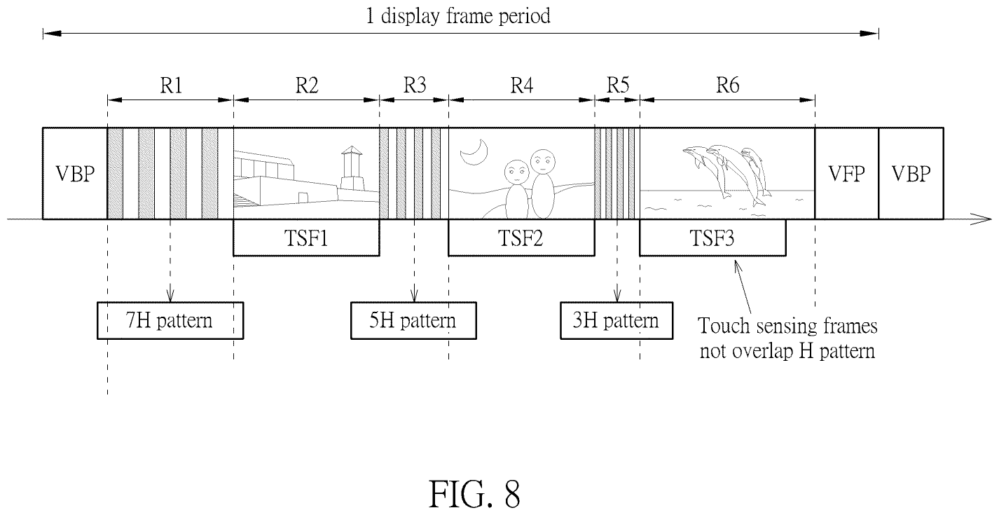

For example, as shown in FIG. 8, the display frame period has more complex display data, which are divided into 6 regions R1-R6 sequentially output in the active period. The regions R1, R3 and R5 have a 7H pattern, a 5H pattern and a 3H pattern, respectively, while the regions R2, R4 and R6 have regular image patterns. In such a situation, it is preferable to allocate the touch sensing frames TSF1-TSF3 in the time periods corresponding to the regions R2, R4 and R6, so that the touch sensing frames TSF1-TSF3 would not overlap the H patterns. As a result, the touch sensing operations performed in the touch sensing frames TSF1-TSF3 may not be interfered with by the larger noises of the H patterns.

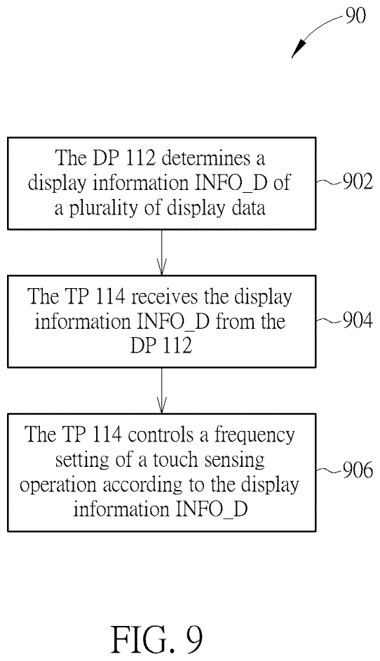

In one or several embodiments, the TP 114 may determine the frequency of performing touch sensing according to the display information INFO_D obtained from the DP 112. FIG. 9 is a flowchart of a touch control process 90 according to an embodiment of the present invention. The touch control process 90 may be implemented in a driver circuit for a touch panel, such as the driver circuit 110 shown in FIG. 1 or 3. As shown in FIG. 9, the touch control process 90 includes the following steps:
Step 902: The DP 112 determines a display information INFO_D of a plurality of display data.
Step 904: The TP 114 receives the display information INFO_D from the DP 112.
Step 906: The TP 114 controls a frequency setting of a touch sensing operation according to the display information INFO_D.

According to the touch control process 90, the DP 112 first determines the display information INFO_D associated with the display data. As mentioned above, the display information INFO_D may indicate that the display data has a specific image pattern, such as the 1H pattern or 2H pattern. An image pattern has a noise profile, where the noise is larger in some frequencies and smaller in some frequencies. Based on the image pattern information, the TP 114 may control the frequency setting of the touch sensing operation; that is, the TP 114 may select a frequency having a smaller noise for touch sensing.

For example, the DP 112 may determine that the display data in the present frame or region have an image pattern which generates a noise in one or several frequency bands. Based on the related information, the TP 114 may perform touch sensing in a frequency out of the frequency band(s).

In several embodiments, as for one or more specific image patterns, the TP 114 may perform touch sensing in a frequency correspondingly. For example, an image pattern may be predetermined to have a minimum noise in a specific frequency; hence, the TP 114 may use this specific frequency to perform touch sensing when the image pattern is detected by the DP 112.

For example, as for various H patterns, the TP 114 may select an optimal frequency to avoid the noise interferences based on the image pattern information obtained from the DP 112. In this embodiment, the TP 114 may know which H pattern is to be displayed in advance, and thus may switch to the optimal frequency during the display period of the H pattern. This may be achieved based on the predicted display content, rather than detecting the noises generated by the displayed images.

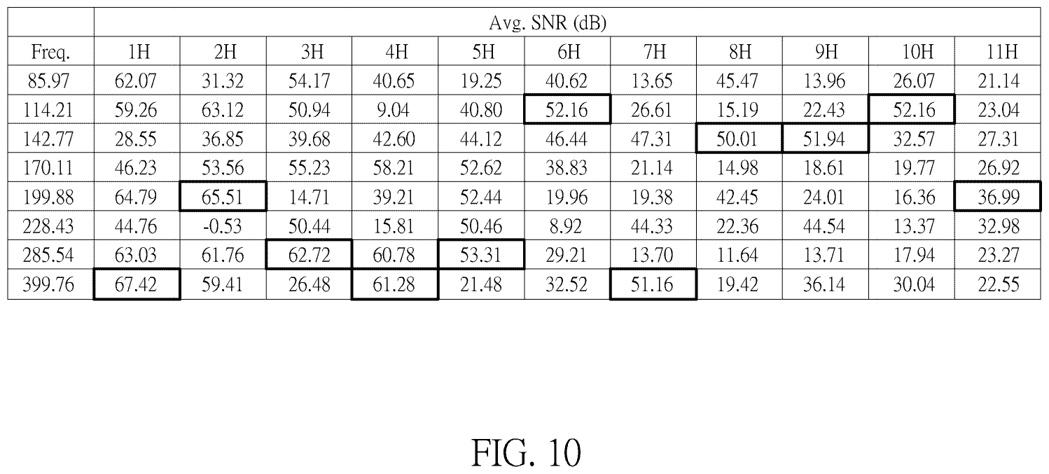

FIG. 10 illustrates a related embodiment, where the TP 114 is configured to perform touch sensing in one of multiple candidate frequencies from 85.97 Hz to 399.76 Hz. Before the touch panel is put in use, several specific patterns may be provided to measure the noises interfering with the touch sensing operations in these candidate frequencies. The noise measurement result of these candidate frequencies under the image patterns may be recorded in a lookup table (LUT), and the TP 114 may determine to perform touch sensing in a selected frequency by referring to the LUT. In this embodiment, the average SNR of each of the 1H to 11H patterns is measured, so as to obtain the LUT recording different SNR values (e.g., dB values) as shown in FIG. 10, where a larger SNR means that the touch sensing operation is less interfered with by noises.

Therefore, according to the image pattern to be displayed, the TP 114 may select one of these candidate frequencies having the maximum SNR to perform touch sensing. For example, as for the 1H, 4H and 7H patterns, the TP 114 may perform touch sensing in the frequency 399.76 Hz, which has a larger SNR than any other candidate frequencies. As for the 2H and 11H patterns, the TP 114 may perform touch sensing in the frequency 199.88 Hz, which has a larger SNR than any other candidate frequencies. As for the 3H and 5H patterns, the TP 114 may perform touch sensing in the frequency 285.54 Hz, which has a larger SNR than any other candidate frequencies. As for the 6H and 10H patterns, the TP 114 may perform touch sensing in the frequency 114.21 Hz, which has a larger SNR than any other candidate frequencies. As for the 8H and 9H patterns, the TP 114 may perform touch sensing in the frequency 142.77 Hz, which has a larger SNR than any other candidate frequencies.

In the prior art, the frequency hopping is performed through noise detection during the touch sensing operation, and thus the control circuit may change the frequency according to the noise detection result. Differently, in the present invention, the TP 114 may control the frequency setting of the touch sensing operation without performing noise detection during the touch sensing operation. The operating frequency is determined when the image pattern is known in advance; hence, the noise detection operation for frequency selection may be omitted. In such a situation, the frequency change is implemented in time, and thus the overall anti-noise performance of touch sensing may be improved.

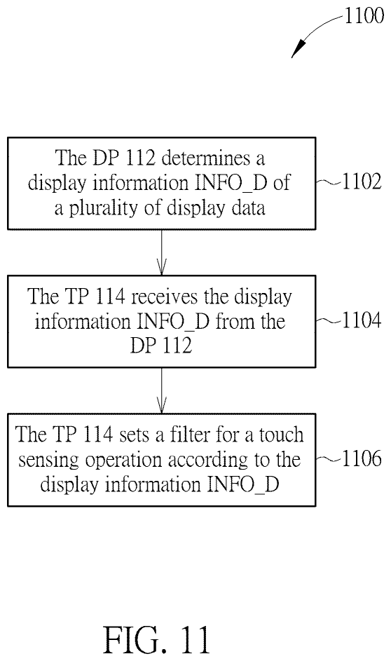

FIG. 11 is a flowchart of a touch control process 1100 according to an embodiment of the present invention. The touch control process 1100 may be implemented in a driver circuit for a touch panel, such as the driver circuit 110 shown in FIG. 1 or 3. As shown in FIG. 11, the touch control process 1100 includes the following steps:
Step 1102: The DP 112 determines a display information INFO_D of a plurality of display data.
Step 1104: The TP 114 receives the display information INFO_D from the DP 112.
Step 1106: The TP 114 sets a filter for a touch sensing operation according to the display information INFO_D.

According to the touch control process 1100, the DP 112 first determines the display information INFO_D associated with the display data, where the display information INFO_D indicates the image pattern of the display data. In this embodiment, the driver circuit 110 may include a touch filter used for passing valid touch signals while filtering out unwanted noise frequencies. Therefore, the TP 114 may set the touch filter appropriately according to the image pattern information.

In general, the H pattern has periodic display data which may generate noises in specific frequencies. Sometimes the touch panel may also be interfered with by other periodic noises such as charger noises. With a suitable setting, the touch filter may effectively filter out the periodic noises.

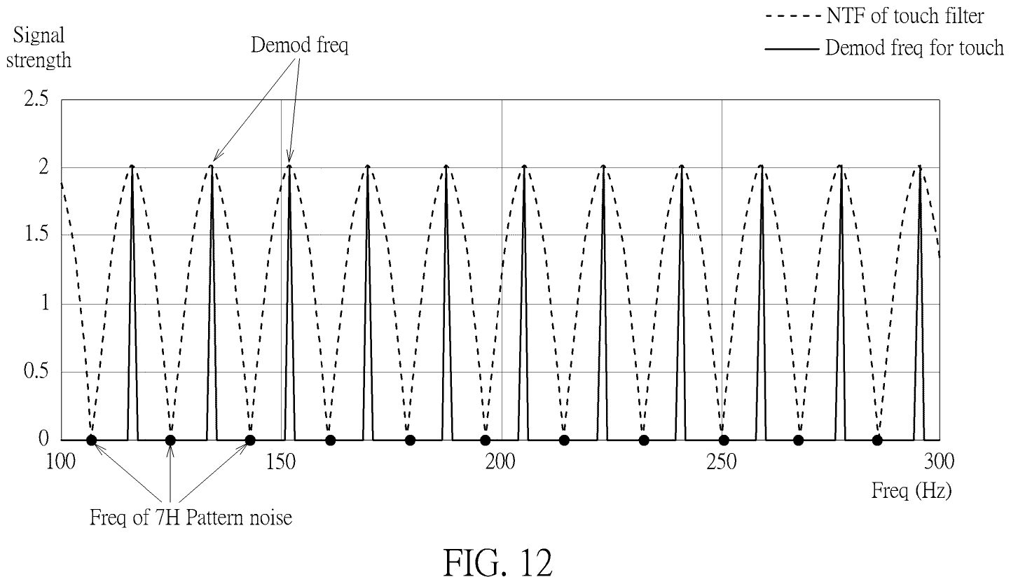

FIG. 12 illustrates an exemplary setting of a touch filter to deal with the noises generated by a 7H pattern according to an embodiment present invention. Due to the periodic characteristics of the 7H pattern, the noises may appear on some frequencies. Therefore, the touch filter may be set to filter out these noise frequencies. FIG. 12 shows the noise transfer function (NTF) of the touch filter, which may be well designed to filter out the target frequencies interfered with by the noises of the 7H pattern. In addition, the touch sensing frequency may be well designed to keep away from these noise frequencies. In other words, the demodulator for touch signals may be set to a frequency away from the frequencies of possible noises generated by the image pattern.

Therefore, as for different H patterns which may generate noises in different frequencies, the touch filter may be set differently to suppress noisy frequencies and pass other frequencies. For example, as for the 7H pattern which may generate noises in one or more first frequencies (or frequency bands), the TP 114 may set the touch filter to filter out the noises in the first frequency(s); as for the 5H pattern which may generate noises in one or more second frequencies (or frequency bands), the TP 114 may set the touch filter in another manner to filter out the noises in the second frequency(s). In addition, when the image pattern changes (within an image frame or between different image frames), the setting of the touch filter may be dynamically adjusted, so as to improve the overall SNR.

In one or several embodiments, the touch filter may be implemented in a digital back-end (DBE) circuit of the TP 114. The DBE circuit, which may be coupled to the AFE circuit (e.g., 314 shown in FIG. 3), may process touch sensing signals received from the AFE circuit to generate touch raw data. The DBE circuit may be coupled between the AFE circuit and the MCU of the TP 114, or may be integrated with the MCU. In an embodiment, an analog-to-digital converter (ADC) may be coupled between the AFE circuit and the DBE circuit, to convert the touch sensing signals into a digital form to be processed by the DBE circuit.

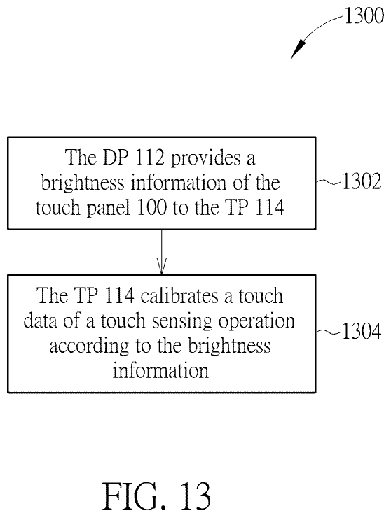

FIG. 13 is a flowchart of a touch control process 1300 according to an embodiment of the present invention. The touch control process 1300 may be implemented in a driver circuit for a touch panel, such as the driver circuit 110 shown in FIG. 1 or 3. As shown in FIG. 13, the touch control process 1300 includes the following steps:
Step 1302: The DP 112 provides a brightness information of the touch panel 100 to the TP 114.
Step 1304: The TP 114 calibrates a touch data of a touch sensing operation according to the brightness information.

According to the touch control process 1300, the DP 112 first obtains the brightness information of the touch panel 100. For example, the brightness information may include the average brightness displayed in a specific region of the image frame or in an entire image frame on the touch panel 100. The average brightness may be obtained from the average grayscale of the display data within the region or image frame, and the related operations are illustrated in FIG. 4 and related paragraphs.

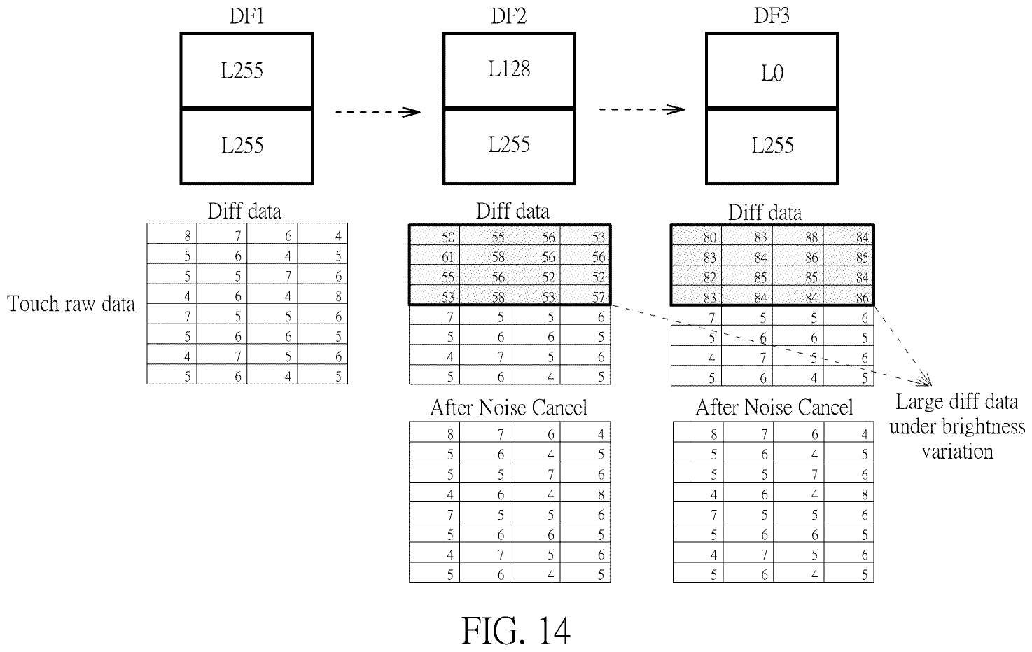

FIG. 14 illustrates the touch raw data of an image frame affected by the brightness of the image according to an embodiment of the present invention. As shown in FIG. 14, there are 3 image frames DF1-DF3 having different image content. The image frame DF1 has an all-white image, which has the maximum grayscale value L255. The image frame DF2 is divided into two regions, of which the lower region shows the white image and has the maximum grayscale value L255, and the upper region shows a gray image and has a medium grayscale value L128. The image frame DF3 is also divided into two regions, of which the lower region shows the white image and has the maximum grayscale value L255, and the upper region shows a black image and has the minimum grayscale value L0. Assuming that there are 32 touch sensors (also referred to as touch sensing electrodes) implemented as an 8×4array, during the touch sensing operation, a touch raw data may be received from each touch sensor in each image frame DF1-DF3. In another embodiment, a touch raw data may be obtained from a combination of multiple adjacent touch sensors.

The data values shown in FIG. 14 may be differential data corresponding to a touch baseline. In this embodiment, the touch baseline may be obtained in the environment of white image. Therefore, in a region showing a non-white image, the sensed differential data may have a larger value in response to the brightness difference between the displayed image and the baseline setting. For example, as shown in FIG. 14, the upper region in the image frame DF2 and the upper region in the image frame DF3 have a larger differential data resulting from the brightness difference. If the differential data exceeds a threshold of touch object determination, the touch sensing result may be affected to generate an error.

Therefore, based on the brightness information received from the DP 112, the TP 114 may calibrate the touch raw data to cancel the data error caused by the average brightness difference. For example, as shown in FIG. 14, in the image frame DF2 or DF3, the touch raw data in the upper region have an unwanted variation while the touch raw data in the lower region might be correct; hence, the TP 114 may shift the touch raw data in the upper region by a differential value according to the difference between the average brightness of the upper region and the average brightness of the lower region. After the touch raw data are shifted, the noises generated from the average brightness difference may be effectively canceled.

Note that the image content of the image frames DF1-DF3 shown in FIG. 14 is merely an exemplary embodiment of the present invention. In another embodiment, an image frame may be divided into more regions displaying more types of different image patterns, and thus the touch raw data may be calibrated accordingly to cancel the noises generated from the average brightness difference. In a further embodiment, the same image frame may display similar content but different image frames may have different average brightness, and thus the shift of touch raw data may be performed on the entire image frame. For example, a first frame may have a first average brightness and a second frame may have a second average brightness; hence, the touch raw data of the first frame and/or the second frame may be shifted by a differential value according to the difference of the first average brightness and the second average brightness.

Also note that the present invention aims at providing a method of controlling the touch panel to eliminate or reduce the noises generated from the display data. Those skilled in the art may make modifications and alterations accordingly. For example, in the touch panel, the noises generated from the display data may interfere with the touch sensing operation in various ways, and thus the present invention may deal with the noises with appropriate approaches to eliminate or reduce the noise interferences. In the embodiment shown in FIG. 14, since the noise is generated from the average brightness or average grayscale within a region, the TP 114 may cancel the noise by uniformly shifting the touch raw data within the region. In the above other embodiments, since the noise may be a local noise generated from the change of display data in specific image patterns, it is difficult to cancel the noise by modifying the overall touch raw data. In such a situation, the TP 114 may deal with the noise by allocating the timing and/or frequency of touch sensing operations to keep away from the timing and/or frequency probably interfered with by the noise. In addition, various anti-noise methods provided by the present invention may be combined to achieve higher touch sensing performance. The anti-noise methods are applied to any type of touch panel, such as an LED panel, OLED panel, and LCD panel, but not limited thereto.

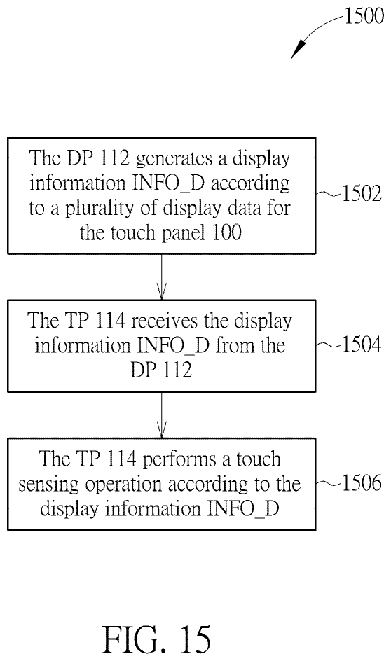

The abovementioned operations of the driver circuit for controlling the touch panel may be summarized into a touch control process 1500, as shown in FIG. 15. The touch control process 1500 may be implemented in the driver circuit 110 shown in FIG. 1 or 3, and includes the following steps:
Step 1502: The DP 112 generates a display information INFO_D according to a plurality of display data for the touch panel 100.
Step 1504: The TP 114 receives the display information INFO_D from the DP 112.
Step 1506: The TP 114 performs a touch sensing operation according to the display information INFO_D.

The detailed implementations and alterations of the touch control process 1500 are illustrated in the above paragraphs, and will not be narrated herein.

Different from the prior art where the anti-noise touch sensing operation is performed after noise detection, the present invention provides a more effective and immediate approach for a driver circuit to deal with the touch noise generated from the display operation. In various embodiments, the DP of the driver circuit may analyze the display content to determine the image pattern and/or average brightness, and send the related display information to the TP of the driver circuit, where the display information may include the image pattern or brightness information, but not limited thereto. Alternatively or additionally, the DP may determine the noise profile based on the display data, and send the related information to the TP. The noise profile may include the noise strength, noise type, and/or noise frequency, but not limited thereto.

Based on the information received from the DP, the TP may take appropriate measures on the touch sensing operation to deal with the noise interference, thereby improving the performance of touch sensing. In an embodiment, based on the brightness information, the TP may shift the touch raw data in a frame or region to cancel the noise generated from the average brightness difference of this frame or region. In an embodiment, the TP may allocate the timing of the touch sensing frames to be adapted to the output timing of the display data in a specific image pattern. In an embodiment, based on the image pattern, the TP may select an optimal frequency to perform touch sensing, so as to avoid the noise interferences generated from the image pattern. In an embodiment, based on the image pattern, the TP may set the touch filter to effectively filter out the noises in specific frequencies that may be generated from the image pattern. These operations of the TP may be performed before the noise interferences appear, and thus may be realized without additional noise detection.

In another embodiment, the DP may further predict the image content, so as to predict the noise profile that may be generated from the display operation. Therefore, the TP may take appropriate measures according to the predicted noise profile, so as to avoid the noise interferences more immediately.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method of controlling a touch panel for a driver circuit, the driver circuit having a display part and a touch part, the method comprising:
generating, by the display part, a display information according to a plurality of display data for the touch panel;
receiving, by the touch part, the display information from the display part; and
performing, by the touch part, a touch sensing operation according to the display information.

2. The method of claim 1, further comprising:
determining a noise according to the display information; and
performing, by the touch part, the touch sensing operation to avoid an interference of the noise.

3. The method of claim 1, wherein the step of the display part generating the display information according to the plurality of display data for the touch panel comprises:
determining, by the display part, a data characteristic of the plurality of display data.

4. The method of claim 3, further comprising:
controlling, by the touch part, a setting of the touch sensing operation according to the data characteristic of the plurality of display data.

5. The method of claim 3, wherein the step of the display part determining the data characteristic of the plurality of display data comprises:
determining, by the display part, a periodicity of a plurality of lines of display data within a display section among the plurality of display data.

6. The method of claim 5, wherein the step of the display part determining the periodicity of the plurality of lines of display data comprises:
detecting, by the display part, a series of data differences of the plurality of lines of display data, to determine the periodicity of the plurality of lines of display data.

7. The method of claim 3, wherein the step of the display part determining the data characteristic of the plurality of display data comprises:
comparing, by the display part, a plurality of current display data among the plurality of display data with a plurality of previous display data among the plurality of display data, to obtain a data difference.

8. The method of claim 3, wherein the step of the display part determining the data characteristic of the plurality of display data comprises:
determining, by the display part, an image pattern corresponding to the plurality of display data in a plurality of lines within an image frame.

9. The method of claim 1, further comprising:
predicting a noise interference of the touch sensing operation according to the plurality of display data to be output to the touch panel in a future time point.

10. A method of controlling a touch panel for a driver circuit, the driver circuit having a display part and a touch part, the method comprising:
determining, by the display part, a periodicity of a plurality of lines of display data;
receiving, by the touch part, an information of the periodicity from the display part; and
determining, by the touch part, to start a touch sensing operation at a time point according to the periodicity.

11. The method of claim 10, wherein the touch sensing operation is performed in a first touch sensing frame and a second touch sensing frame, and the step of the touch part determining to start the touch sensing operation at the time point according to the periodicity comprises:
starting, by the touch part, the first touch sensing frame at a first time point corresponding to a first line of display data among the plurality of lines of display data; and
starting, by the touch part, the second touch sensing frame at a second time point corresponding to a second line of display data among the plurality of lines of display data;
wherein the first line of display data and the second line of display data have a same data characteristic.

12. The method of claim 11, wherein the first line of display data and the second line of display data have exactly same data values.

13. The method of claim 11, wherein a first data difference corresponding to the first line of display data is equal to a second data difference corresponding to the second line of display data.

14. The method of claim 11, wherein the plurality of lines of display data have a 2N-line period, and a distance between the first time point and the second time point equals X lines, wherein X, N are positive integers, and X is a multiple of 2N.

15. The method of claim 10, wherein the plurality of lines of display data comprise a plurality of third lines of display data having an image pattern, and the method further comprises:
performing, by the touch part, the touch sensing operation at a touch sensing frame away from a time period in which the plurality of third lines of display data are output to the touch panel.

16. A method of controlling a touch panel for a driver circuit, the driver circuit having a display part and a touch part, the method comprising:
determining, by the display part, a display information of a plurality of display data;
receiving, by the touch part, the display information from the display part; and
controlling, by the touch part, a frequency setting of a touch sensing operation according to the display information.

17. The method of claim 16, wherein the plurality of display data have an image pattern, and the step of the touch part controlling the frequency setting of the touch sensing operation comprises:
performing, by the touch part, the touch sensing operation in a frequency corresponding to the image pattern.

18. The method of claim 16, wherein the plurality of display data have an image pattern, and the step of the touch part controlling the frequency setting of the touch sensing operation comprises:
selecting, by the touch part, a frequency from a plurality of candidate frequencies for performing the touch sensing operation according to the image pattern.

19. The method of claim 18, wherein the touch part controls the frequency setting of the touch sensing operation without performing noise detection during the touch sensing operation.

20. The method of claim 16, wherein the plurality of display data have an image pattern which generates a noise in a first frequency band, and the step of the touch part controlling the frequency setting of the touch sensing operation comprises:
performing, by the touch part, the touch sensing operation in a frequency out of the first frequency band.

21. The method of claim 16, wherein the step of the touch part controlling the frequency setting of the touch sensing operation comprises:
determining, by the touch part, to perform the touch sensing operation in a frequency by referring to a lookup table, which records a noise measurement result of a plurality of candidate frequencies under a plurality of image patterns.

22. A method of controlling a touch panel for a driver circuit, the driver circuit having a display part and a touch part, the method comprising:
determining, by the display part, a display information of a plurality of display data;
receiving, by the touch part, the display information from the display part; and
setting, by the touch part, a filter for a touch sensing operation according to the display information.

23. The method of claim 22, wherein the plurality of display data have an image pattern which generates a noise in a first frequency, and the step of the touch part setting the filter for the touch sensing operation comprises:
setting, by the touch part, the filter to filter out the noise in the first frequency.

24. The method of claim 22, wherein the step of the touch part setting the filter for the touch sensing operation comprises:
setting, by the touch part, the filter to filter out a noise in a first frequency for a first image pattern; and
setting, by the touch part, the filter to filter out a noise in a second frequency different from the first frequency for a second image pattern.

25. A method of controlling a touch panel for a driver circuit, the driver circuit having a display part and a touch part, the method comprising:
providing, by the display part, a brightness information of the touch panel to the touch part; and
calibrating, by the touch part, a touch data of a touch sensing operation according to the brightness information.

26. The method of claim 25, wherein the brightness information comprises an average brightness of a region or a frame of the touch panel.

27. The method of claim 25, wherein the touch panel has a first average brightness in a first region and a second average brightness in a second region, and the step of the touch part calibrating the touch data of the touch sensing operation comprises:
performing, by the touch part, the touch sensing operation to obtain a plurality of first touch data in the first region and obtain a plurality of second touch data in the second region; and
shifting, by the touch part, the plurality of second touch data by a differential value according to a difference of the first average brightness and the second average brightness.

28. The method of claim 25, wherein the touch panel has a first average brightness in a first frame and a second average brightness in a second frame, and the step of the touch part calibrating the touch data of the touch sensing operation comprises:
performing, by the touch part, the touch sensing operation to obtain a plurality of first touch data in the first frame;
performing, by the touch part, the touch sensing operation to obtain a plurality of second touch data in the second frame; and
shifting, by the touch part, the plurality of second touch data by a differential value according to a difference of the first average brightness and the second average brightness.
